(19) United States
(12) Patent Application Publication
(10) Pub. No.: US 2013/0080751 A1
(43) Pub. Date: Mar. 28, 2013

(54) METHOD AND DEVICE FOR UPDATING BIOS PROGRAM FOR COMPUTER SYSTEM

(71) Applicant: Feng Yun Lin, New Taipei (TW)

(72) Inventor: Feng Yun Lin, New Taipei (TW)

(21) Appl. No.: 13/302,215

(22) Filed: Nov. 22, 2011

(30) Foreign Application Priority Data
Sep. 26, 2011 (TW) 100134658

(51) Int. Cl. G06F 15/177; G06F 9/44

(52) U.S. Cl. 713/1

(57) ABSTRACT

The present invention discloses a method and a device for updating a BIOS program for a computer system. The method according to one embodiment of the present invention includes the steps of: determining whether the computer system enters an update mode; enabling a network device if the computer system enters the update mode; connecting to a BIOS server via a network; downloading BIOS update information to the computer system from the BIOS server, and updating the BIOS program of the computer system based on the BIOS update information.

### RELATED APPLICATION DATA

This application claims priority to Taiwanese non-provisional patent application no. 100134658, filed Sep. 26, 2011, entitled “Method and Device for Updating BIOS Program for Computer System,” the contents of which are hereby incorporated by reference for all purposes as if fully set forth herein.

### FIELD OF THE INVENTION

The present invention relates to a method and device for updating a BIOS program for a computer system.

### BACKGROUND

In a modern computer system, when the computer system is turned on, the computer system executes a BIOS (Basic Input/Output System) program stored in an external memory by a CPU (Central Processing Unit) to complete the turn-on operation. The external memory is usually a non-volatile memory. The BIOS program is the most basic software program code in the motherboard hardware system, and the main functions of the BIOS include POST (Power-On Self-Test) during the turning on of the computer system, initial operation, providing component basic setting and providing the resident-program library.

In the computer system, the BIOS program is the most important start program. When the computer system turns on, the BIOS is started first, the OS (Operating System) is started next, and then programs are executed. If the BIOS starts with en error, then the computer system cannot operate normally.

In the prior art, if the BIOS program is damaged, the update program and a BIOS image file, which are stored in a floppy disc, compact disc or USB (Universal Serial Bus) device are needed to load the update program and the BIOS image to record the BIOS image to the external memory.

However, most users do not have a floppy disc, compact disc or USB device available for the previous update program and the BIOS image. In such case, the user must find another update program and BIOS image suitable for the computer system and store them in floppy, compact disc or USB device to update the BIOS. Thus, the conventional BIOS program update method is very complex and requires a lot of time. If the update program and the BIOS image cannot be found, the computer system needs to be sent to the factory, consuming more time and incurring more expense.

Therefore, it is necessary to provide a method and device for updating BIOS program for the computer system to solve the previous problem.

### SUMMARY OF THE INVENTION

Embodiments of the invention provide a method for updating a BIOS program for a computer system. In an embodiment, the method of the invention includes the steps of: determining whether the computer enters an update mode; activating a network device if the computer enters the update mode; connecting to a BIOS server via a network; downloading BIOS update information to the computer system from the BIOS server; and updating the BIOS program of the computer system based on the BIOS update information.

Embodiments of the invention provide a device for updating a BIOS program for a computer system. In an embodiment, the device of the invention includes: an update mode driving device, a network device, a memory and a controller. The update mode driving device is used to determine whether the computer enters an update mode, and to generate an update mode signal. The network device is connected to the update mode driving device, and the network device is activated based on the update mode signal. The network device connects to a BIOS server via a network, and downloads BIOS update information from the BIOS server. The memory is used to store the BIOS update information. The controller updates the BIOS of the computer system based on the BIOS update information.

### BRIEF DESCRIPTION OF THE DRAWINGS

The method and device of the present invention can be understood according to the previous explanation and the following figures.

FIG. 1 shows the flow chart of the BIOS program update method for the computer system according to one embodiment of the present invention;

FIG. 2 shows the circuit block diagram of the BIOS program update device for the computer system according to one embodiment of the present invention;

FIG. 3 shows the circuit block diagram of the update mode driving device according to one embodiment of the present invention; and

FIG. 4 shows the circuit block diagram of the network device according to one embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

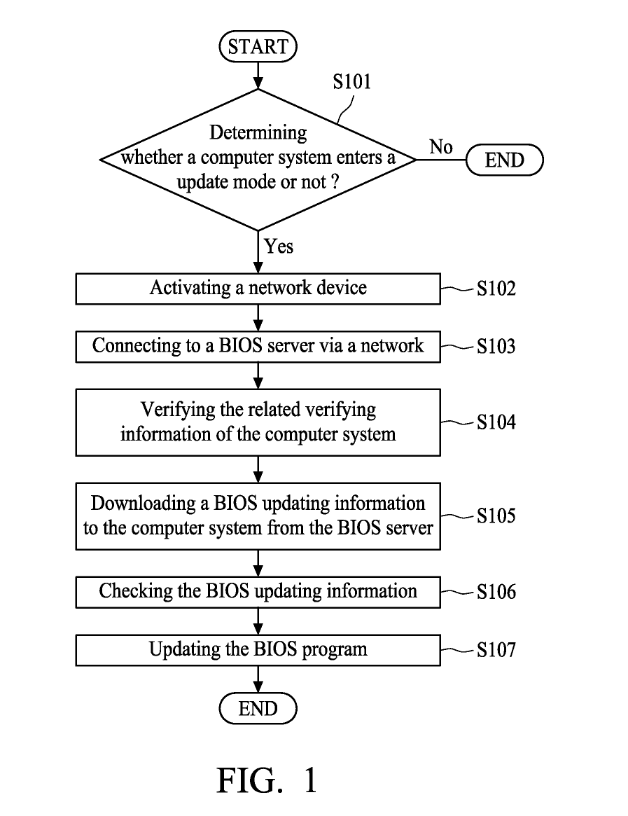

FIG. 1 shows the flow chart of the BIOS program update method for the computer system according to one embodiment of the present invention. In Step S101, a determination is made as to whether the computer system enters an update mode. In the present embodiment, the step of determining whether the computer system enters the update mode further comprises a detecting step to detect whether the BIOS program is normal. If the BIOS program is not normal or is damaged, the computer system enters the update mode. Both the above steps can be used for the turn-on BIOS check of the computer system or for the BIOS check in operation. The method can also be used in the manufacturing stage of the computer system. When the computer system needs to download the BIOS program, the step of determining whether the computer system enters the update mode further comprises an active update step to enable the computer system to actively enter the update mode.

In Step S102, if the computer system enters the update mode, a network device is activated. In Step S103, the computer system is connected to a BIOS server via a network. In Step S104, in one embodiment of the present invention, after Step 103 the method of the invention further comprises a verifying step to provide related verifying information of the computer system to the BIOS server, and the related verifying information of the computer system is verified by the BIOS server. The related verifying information of the computer system can be the brand, model and version of the BIOS of the computer system so that the BIOS server verifies the legality and correctness of the related verifying information.

In Step S105, BIOS update information is downloaded to the computer system from the BIOS server. According to the related verifying information of the computer system, the BIOS server can provide correct version of the BIOS update information. The user can download the BIOS update information to the computer system. In one embodiment of the present invention, the BIOS update information can be a BIOS image file.

In Step S106, in one embodiment of the present invention, after downloading the BIOS update information, a check step is performed to check the BIOS update information in order to ensure the legality and correctness of the version of the BIOS update information.

In Step S107, the BIOS program of the computer system is updated based on the BIOS update information. After checking the correctness of the BIOS update information, the computer system uses the BIOS update information to update the BIOS program. Generally, the BIOS program includes a main area and a recovery area. The recovery area can check whether the information of the main area is normal. When updating the BIOS program, the update can apply either to only the information of the main area or simultaneously to both the main area and the recovery area.

According to one embodiment of the present invention, when the computer system enters the update mode, the computer system automatically connects to the network and connects to the BIOS server via the network in order to detect and download the BIOS update information, and then the BIOS program of the computer system is updated automatically. Therefore, the update method of the BIOS program of the present invention can simplify the process and save a lot of time. Specialized knowledge or technology is not needed, and complex steps need not be performed, to update the BIOS program. The user also does not need extra floppy discs, compact discs or USB devices to store the BIOS program or the BIOS image file. Furthermore, the user doesn't need another computer system to search and download the update program and the BIOS image file of the computer system.

In order to increase the suitability of the BIOS program update method of the computer system, in one embodiment of the present invention, the BIOS program update method further comprises a selection step before activating the network device in order to select one of a plurality of download methods of BIOS update information. The download methods of the BIOS update information comprise a network download method and an external storage download method, wherein the network download method uses the previous network automatic download method. The external storage device download method uses at least one external storage device to store the BIOS update information in order to download the information to the computer system and update the BIOS program. Therefore, the BIOS program update method of the present invention can select the BIOS program in the external storage device to update.

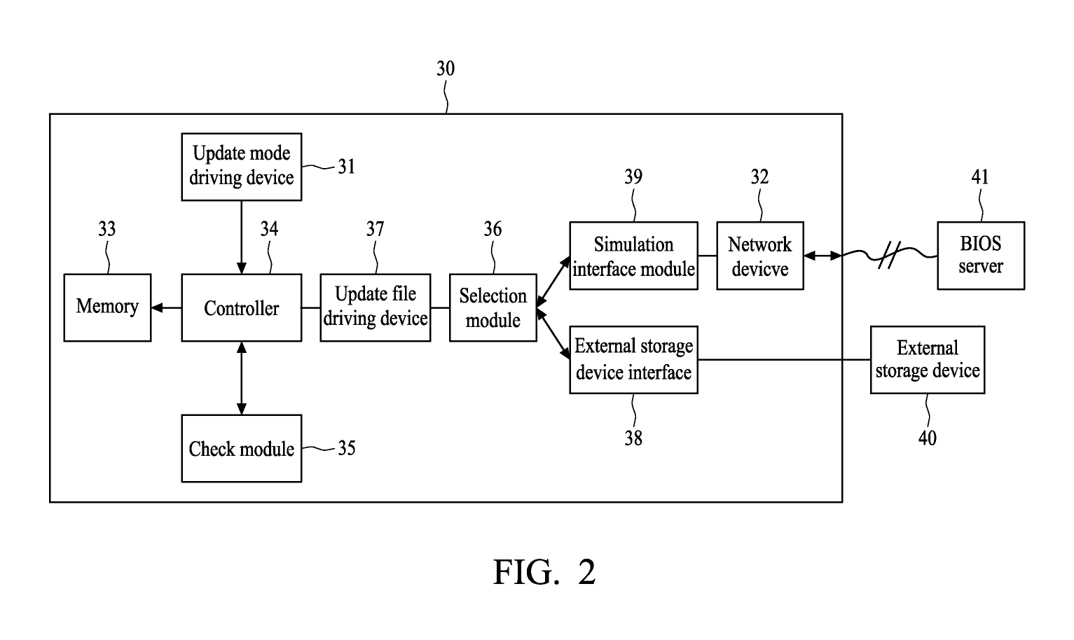

FIG. 2 shows the circuit block diagram of the BIOS program update device for the computer system according to one embodiment of the present invention. In the embodiment, the computer system can be a personal computer, such as desktop, notebook, touch pad computer or other computing device. The BIOS program update device 30 for the computer system in the present invention comprises: an update mode driving device 31, a network device 32, a memory 33 and a controller 34. The update mode driving device 31 determines whether the computer system enters an update mode, and generates an update mode signal to the network device 32.

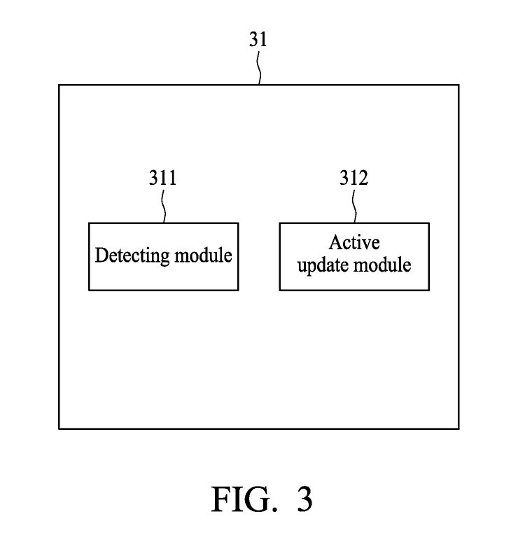

FIG. 3 shows the circuit block diagram of the update mode driving device according to one embodiment of the present invention. Referring to FIG. 2 and FIG. 3, the update mode driving device 31 comprises a detecting module 311 and an active update module 312. The detecting module 311 is used to detect whether the BIOS program of the computer system is normal. If the BIOS program is not normal, the computer system enters the update mode. The active update module 312 triggers the computer system to actively enter the update mode. For example, during the manufacturing stage of the computer system, when the computer system needs to download the BIOS program, the computer system actively enters the update mode.

Referring to FIG. 2, the network device 32 connects to the update mode driving device 31 and automatically activates the network device 32 based on the update mode signal, the network device 32 connects to a BIOS server 41 via a network, and BIOS update information is downloaded to the network device 32 from the BIOS server 41.

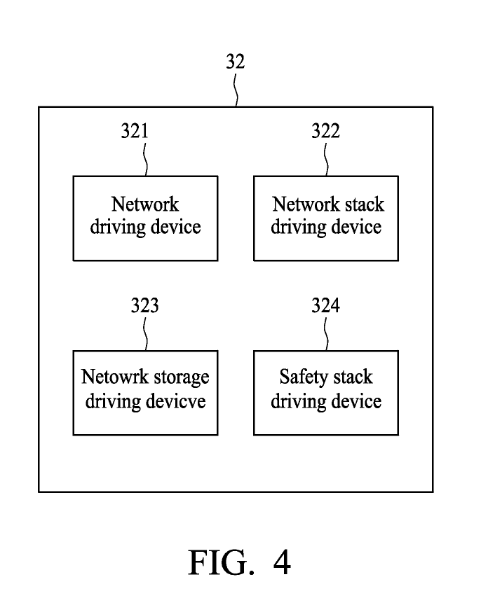

FIG. 4 shows the circuit block diagram of the network device according to one embodiment of the present invention. Referring to FIG. 2 and FIG. 4, the network device 32 comprises a network driving device 321, a network stack driving device 322, a network storage driving device 323 and a safety stack driving device 324. The network driving device 321 automatically activates the network device 32 based on the update mode signal, the network stage driving device 322 generates data packets based on a network protocol, and the network storage driving device 323 communicates with the BIOS server 41. The safety stack driving device 324 provides the related verifying information of the computer system to the BIOS server 41, and the related verifying information of the computer system is verified by the BIOS server 41. In one embodiment of the present invention, the related verifying information of the computer system can be the band, model and version of BIOS program of the computer system.

Referring to FIG. 2, the memory 33 stores the BIOS update information. The controller 34 updates the BIOS program of the computer system based on the BIOS update information. The BIOS program update device 30 of the present invention further comprises a check module 35 to check the legality and correctness of the BIOS update information to avoid any illegality or incorrectness of the version of the BIOS update information.

The BIOS program update device 30 of the present invention further comprises a selection module 36 to provide a plurality of BIOS update information download options. The user can select one of the BIOS update information download options. The BIOS update information download options comprise a network download option and an external storage device download option. The BIOS program update device 30 of the present invention further comprises a simulation interface module 39 to connect the selection module 36 and the network device 32 in order to communicate with the network device 32. The network download option uses the simulation interface module 39 and the network device 32 to automatically connect to the network and download the BIOS update information.

The external storage device download option uses the external storage device to download the BIOS update information. The BIOS program update device 30 of the present invention further comprises at least one external storage device interface 38 to communicate with at least one external storage device 40 in order to download and store the BIOS update information of the external storage device 40. Since at least one external storage device 40 stores much information, in order to automatically access the BIOS update information from at least one external storage device 40, the BIOS program update device 30 of the present invention further comprises an update file driving device 37 to automatically select the BIOS update information from at least one external storage device 40.

Therefore, the BIOS program update device of the computer system of the present invention can achieve the effect of the BIOS program update method of the present invention. The user needs no extra external storage devices or other computer systems. The user can easily update the computer system by the BIOS program update device of the present invention.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for updating a BIOS program for a computer system, comprising the steps of:
determining whether the computer system enters an update mode;
activating a network device if the computer system enters the update mode;
connecting to a BIOS server via a network;
downloading BIOS update information to the computer system from the BIOS server; and
updating the BIOS program of the computer system based on the BIOS update information.

2. The method according to claim 1, wherein the step of determining whether the computer system enters the update mode further comprises a detecting step to detect whether the updated BIOS program is normal, and if the updated BIOS program is not normal, the computer system enters the update mode.

3. The method according to claim 1, before the step of activating the network device, further comprising a selection step to select one of a plurality of download methods of the BIOS update information.

4. The method according to claim 1, wherein the download methods of the BIOS update information comprise a network download method and an external storage device download method.

5. The method according to claim 4, wherein the external storage download method uses at least one external storage device to store the BIOS update information for downloading to the computer system.

6. The method according to claim 1, after the step of connecting to the BIOS server, further comprising a verifying step to provide related verifying information of the computer system to the BIOS server, wherein the BIOS server verifies the related verifying information of the computer system.

7. The method according to claim 1, after the step of downloading the BIOS update information, further comprising a check step to check the legality and correctness of the BIOS update information.

8. The method according to claim 1, wherein the step of determining whether the computer system enters the update mode further comprises an active update step in the manufacturing stage of the computer system to enable the computer system to actively enter the update mode.

9. A device for updating a BIOS program for a computer system, comprising:
an update mode driving device for determining whether the computer system enter the update mode, and generating an update mode signal;
a network device connecting to the update mode driving device, wherein the network device is activated based on the update mode signal, then the network device connects to a BIOS server via a network and downloads BIOS update information from the BIOS server;
a memory for storing the BIOS update information; and
a controller for updating the BIOS program of the computer system based on the BIOS update information.

10. The device according to claim 9, wherein the update mode driving device further comprises a detecting module to detect whether the BIOS program of the computer system is normal and if the updated BIOS program is not normal, the computer system enters the update mode.

11. The device according to claim 9, further comprising a selection module to provide a plurality of BIOS update information download options, wherein user can select one of the BIOS update information download options.

12. The device according to claim 11, wherein the BIOS update information download options comprise a network download option and a download option of an external storage device.

13. The device according to claim 12, further comprising at least one external storage device interface to communicate at least one external storage device to download and store the BIOS update information of the at least one external storage device.

14. The device according to claim 13, further comprising an update file driving device to select the BIOS update information from the at least one external storage device.

15. The device according to claim 9, wherein the network device comprises a safety stack driving device to provide the related verifying information of the computer system to the BIOS server, wherein the related verifying information of the computer system is verified by the BIOS server.

16. The device according to claim 9, wherein the network device further comprises a network driving device, a network stack driving device and a network storage driving device, the network driving device activates the network device based on the update mode signal, the network stack driving device generates data packet based on a network protocol, and the network storage driving device communicates with the BIOS server.

17. The device according to claim 9, further comprising a check module to check the legitimacy and correctness of the BIOS update information.

18. The device according to claim 9, wherein the update model driving device further comprises an active update module to enable the computer system to actively enter the update mode.

19. The device according to claim 9, further comprising a simulation interface module to communicate with the network device.
